(19) United States
(12) Patent Application Publication
(10) Pub. No.: US 2024/0163607 A1
(43) Pub. Date: May 16, 2024

(54) DYNAMIC IMPEDANCE BALANCING SYSTEM

(71) Applicant: Epix Audio, LLC, Round Rock, TX (US)

(72) Inventors: Rocky Lain Hardie, Austin, TX (US); Konstantin Maerz, Munich (DE)

(21) Appl. No.: 18/506,514

(22) Filed: Nov. 10, 2023

Related U.S. Application Data
(60) Provisional application No. 63/424,526, filed on Nov. 11, 2022.

(51) Int. Cl. H04R 3/04; H04R 1/10

(52) U.S. Cl. CPC H04R 3/04; H04R 1/1016; H04R 2225/025

(57) ABSTRACT

Circuits and system are described for an in-ear audio system that delivers high quality sound into an ear canal of the user using a balanced armature loudspeaker design. The balanced armature loudspeaker design includes a Trebuchet Cell configured to linearize the impedance response of the loudspeaker components and thereby improve the quality of the output sound waves.

### CROSS-REFERENCE TO RELATED APPLICATION(S)

This application claims priority to U.S. Provisional Application No. 63/424,526 filed on Nov. 11, 2022, and entitled “Impedance Control,” which is incorporated herein by reference in its entirety.

### BACKGROUND

The use of miniature loudspeakers with a “Balanced Armature” architecture have become more and more popular with the growth of hearing-aid and headphone markets. However, the balanced armature loudspeakers provide a non-linear impedance response that is often inferior to those provided by conventional digital dynamic drivers.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example pictorial view of a balanced armature loudspeaker, according to some implementations.

FIG. 2 is another example pictorial view of a balanced armature loudspeaker, according to some implementations.

FIG. 3 is an example graph of a balanced armature loudspeaker including a Trebuchet Cell, according to some implementations.

### DETAILED DESCRIPTION

Described herein is a miniature loudspeaker design of the “Balanced Armature” architecture for use in hearing-aids and headphones. The miniature loudspeaker, discussed herein, provides technical advantages compared to loudspeakers with conventional dynamic driver architectures without the disadvantage in the non-linear impedance response of conventional miniature loudspeakers, which includes impedance peaks around a resonance frequency of the conventional loudspeaker's mechanical structure. Accordingly, the miniature loudspeaker design, discussed herein improves the overall tonality and congruity of sound being output. For example, conventional architectures that include frequency-dependent impedance fluctuation have undesirable effects on the audio output including sound quality fluctuations, frequency dependent voltage consumption (which causes variation in volume or loudness), and frequency dependent phase response (which is known to cause difficulties in the human brains' ability to place sound-cues in space or a physical environment, thereby increasing listening fatigue).

In some cases, a balanced armature loudspeaker is a type of transducer used in headphones, hearing aids, personal sound amplifiers, and in-ear monitors to convert electrical signals into sound. The balanced armature loudspeaker may include a small armature, which is a coil of wire suspended between two magnets. When an electrical current flows through the coil, the coil may create a magnetic field that interacts with the magnets, causing the armature to pivot back and forth. This motion drives a diaphragm attached to one end of the armature, which in turn produces sound waves and output audio signals. The balanced armature speakers may be both efficient and precise in reproducing sound, especially in the mid and high-frequency ranges.

In some cases, the balance armature miniature loudspeaker design, discussed herein, may include an electro-acoustical system that includes a Trebuchet Cell comprising a capacitor and a resistor placed in parallel to the loudspeaker components. The Trebuchet Cell may be configured such that when the balanced armature loudspeaker components' inductance starts to rise, the overall impedance is equalized as a function of the voltage supply shifting. During use, the inductance rises primarily around a balanced armature mechanical resonance-frequency. The increase in inductance at the resonance-frequency causes the impedance of the loudspeaker components to likewise rise.

In one implementation, the balance armature miniature loudspeaker design may include first loudspeaker components and second loudspeaker components contained within the same enclosure (casing, housing, or the like) and configured in parallel within the balance armature miniature loudspeaker design circuitry. The use of the first loudspeaker components and the second loudspeaker components within the same enclosure causes, in some examples, two sets of impedance-spikes at, in some cases, two different resonance-frequencies. When the first loudspeaker components and the second loudspeaker components are in parallel the balance armature miniature loudspeaker design is capable of reaching higher levels of audio (e.g., loudness, volume, and the like). In this design the Trebuchet Cell may be configured in parallel with both the first loudspeaker components and the second loudspeaker components.

As one specific example, the balance armature miniature loudspeaker design and the Trebuchet Cell may include an approximately 15 ohms resistor and an approximately 5 micro farad (uF) capacitor in series to each other and in parallel to each of the first loudspeaker components and the second loudspeaker components. In other examples, the resistor may be between approximately 10 ohms and 20 ohms and the capacitor may be between approximately 2.5 uF and 7.5 uF.

In some cases, the balance armature miniature loudspeaker design may utilize a Zobel-Filter in place of the Trebuchet Cell to shift the voltage supply as a function of the impedance change.

In some cases, the loudspeaker may include dynamic speakers (that use a diaphragm attached to a coil in a magnetic field to produce sound), electrostatic speakers (that uses a thin, charged diaphragm suspended between two perforated plates), planar magnetic speakers, horn-loaded speakers (that use a flared structure to increase efficiency and direct sound in a specific direction), subwoofers, and the like.

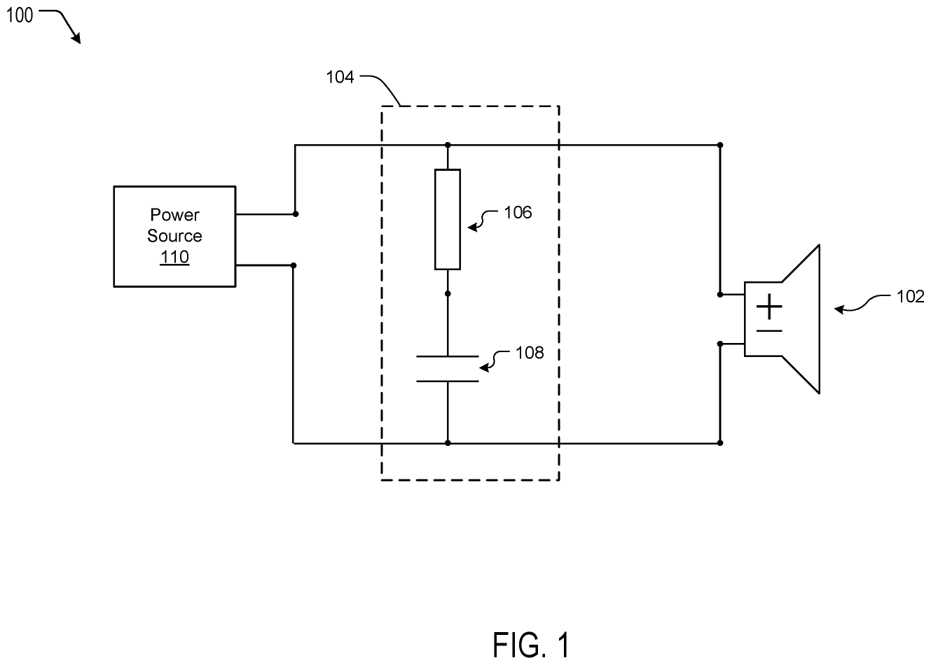

FIG. 1 is an example pictorial view of a balanced armature loudspeaker design, according to some implementations. In the current example, the balanced armature loudspeaker 100 includes loudspeaker component 102 coupled to a Trebuchet Cell 104. In this example, a positive electrode of the loudspeaker component 102 is coupled to a first electrode of a first resistor 106 of the Trebuchet Cell 104 and a negative electrode of the loudspeaker component 102 is coupled to a first electrode of a first capacitor 108 of the Trebuchet Cell 104. Within the Trebuchet Cell 104, a second electrode of the first resistor 106 is coupled to a second electrode of the first capacitor 108. In this manner, the Trebuchet Cell 104 may be coupled in parallel to the loudspeaker component 102.

The Trebuchet Cell 104 may be further coupled to a power source 110 (such as a battery or the like). For example, the first electrode of the first resistor 106 may be coupled to a first electrode (e.g., a positive electrode) of the power source 110 and the first electrode of the capacitor 108 may be coupled to a second electrode (e.g., a negative electrode) of the power source 110. In this manner, the Trebuchet Cell 104 is coupled between the loudspeaker component 102 and the power source 110. Accordingly, as the inductance of the loudspeaker component 102 increases, the overall impedance is equalized by the Trebuchet Cell 104 as a function of the voltage supply shifting, thereby improving sound quality compared with conventional balance armature miniature loudspeaker designs.

In the current example, only a first resistor 106 and the first capacitor 108 are illustrated. It should be understood that any number of resistors and capacitors may be utilized to form the Trebuchet Cell 104. As one specific example, the balance armature miniature loudspeaker 100 and the Trebuchet Cell 104 may include an approximately 15 ohms resistance via one or more resistors (including the first resistor 106) and an approximately 5 uF capacitance via one or more capacitors (including the first capacitor). In other examples, the balance armature miniature loudspeaker 100 and the Trebuchet Cell 104 may include between approximately 10 and 20 ohms resistance via one or more resistors (including the first resistor 106) and an approximately 2.5 and 7.5 uF capacitance via one or more capacitors (including the first capacitor).

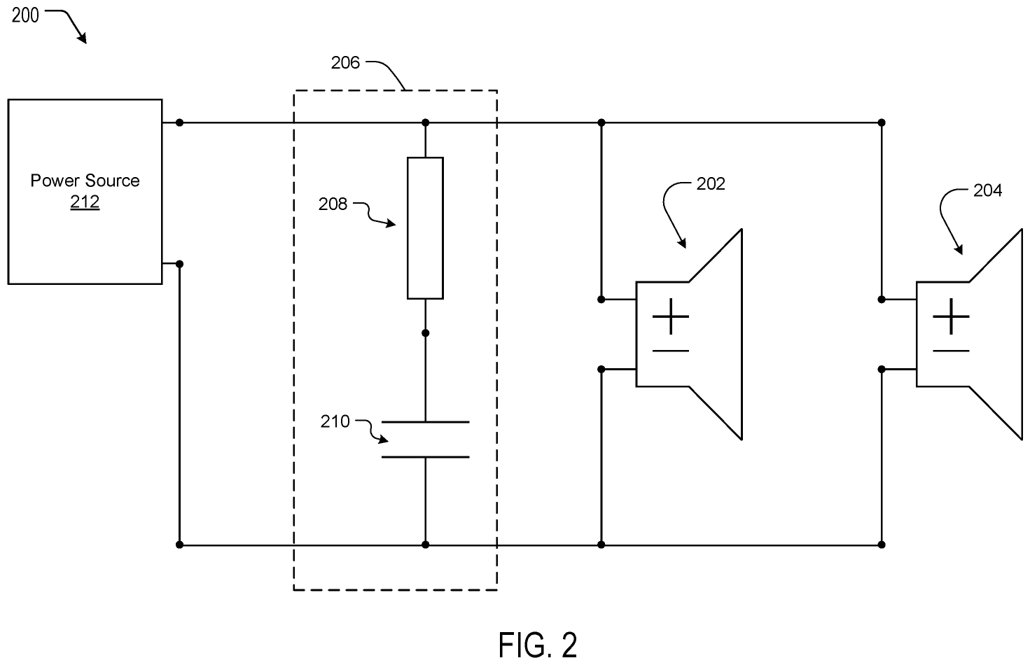

FIG. 2 is another example pictorial view of a balanced armature loudspeaker 200, according to some implementations. In the current example, the balanced armature loudspeaker 200 includes a first loudspeaker component 202 and a second loudspeaker component 204. The first loudspeaker component 202 may be coupled in parallel with the second loudspeaker component 204. For instance, a first electrode of the first loudspeaker component 202 may be coupled to a first electrode of the second loudspeaker component 204 and a second electrode of the first loudspeaker component 202 may be coupled to a second electrode of the second loudspeaker component 204. In this manner, use of the first loudspeaker component 202 and the second loudspeaker component 204 in the balance armature loudspeaker 200 allows for the output of the balance armature loudspeaker 200 to reach increased loudness, higher volumes, and the like. In some examples, the first loudspeaker component 202 and the second loudspeaker component 204 may be a paired of tuned loudspeakers.

Both the first loudspeaker component 202 and the second loudspeaker component 204 may be coupled in parallel to a Trebuchet Cell 206. In this example, a positive electrode of the first loudspeaker component 202 and the second loudspeaker component 204 are coupled to a first electrode of a first resistor 208 of the Trebuchet Cell 206 and a negative electrode of the first loudspeaker component 202 and the second loudspeaker component 204 are coupled to a first electrode of a first capacitor 210 of the Trebuchet Cell 206. Within the Trebuchet Cell 206, a second electrode of the first resistor 208 is coupled to a second electrode of the first capacitor 210. In this manner, the Trebuchet Cell 206 may be coupled in parallel to the first loudspeaker component 202 and the second loudspeaker component 204.

The Trebuchet Cell 206 may be further coupled to a power source 212 (such as a battery or the like). For example, the first electrode of the first resistor 208 may be coupled to a first electrode (e.g., a positive electrode) of the power source 212 and the first electrode of the capacitor 210 may be coupled to a second electrode (e.g., a negative electrode) of the power source 212. In this manner, the Trebuchet Cell 206 is coupled between the second loudspeaker component 206 and the power source 212. Accordingly, as the inductance of the first loudspeaker component 202 and the second loudspeaker component 204 increases, the overall impedance is equalized by the Trebuchet Cell 206 as a function of the voltage supply shifting, thereby improving sound quality compared with conventional balance armature miniature loudspeaker designs.

In the current example, only a first resistor 208 and the first capacitor 210 are illustrated. It should be understood that any number of resistors and capacitors may be utilized to form the Trebuchet Cell 206. As one specific example, the balance armature miniature loudspeaker 200 and the Trebuchet Cell 206 may include an approximately 15 ohms resistance via one or more resistors (including the first resistor 208) and an approximately 5 uF capacitance via one or more capacitors (including the first capacitor). In other examples, the balance armature miniature loudspeaker 200 and the Trebuchet Cell 206 may include between approximately 10 and 20 ohms resistance via one or more resistors (including the first resistor 208) and an approximately 2.5 and 7.5 uF capacitance via one or more capacitors (including the first capacitor).

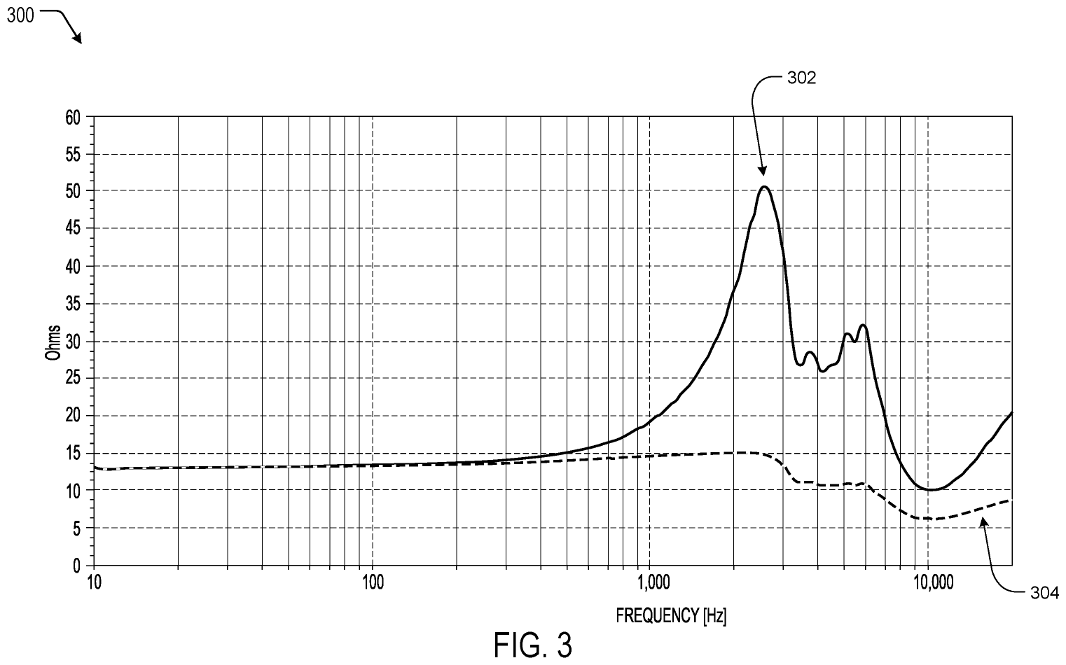

FIG. 3 is an example graph 300 of a balanced armature loudspeaker including a Trebuchet Cell, according to some implementations. In the current example, the solid line 302 illustrates an example impedance response of a conventional balanced armature loudspeaker including a spike at between 1,000 Hertz (Hz) and 10,000 Hz. However, the dashed line 304 illustrate an example impedance response of a balanced armature loudspeaker discussed herein, such as the balanced armature loudspeaker 100 or 200 discussed above. As illustrated, the balanced armature loudspeaker discussed herein, shows linearization over the whole spectrum when compared with a conventional design.

### EXAMPLE CLAUSES

A. An in-ear audio device comprising: a first loudspeaker component having a first electrode and a second electrode; a resistor having a first electrode and a second electrode, the first electrode of the resistor coupled to the first electrode of the first loudspeaker component; a capacitor having a first electrode and a second electrode, the first electrode of the capacitor coupled to the second electrode for the first loudspeaker component and the second electrode of the capacitor coupled to the second electrode of the resistor.

B. The in-ear audio device of paragraph A, further comprising: a power source having a first electrode and a second electrode, the first electrode of the power source coupled to the first electrode of the resistor and the second electrode of the power source coupled to the first electrode of the capacitor.

C. The in-ear audio device of paragraph A, wherein the capacitor and the resistor are components of a Trebuchet Cell.

D. The in-ear audio device of paragraph A, wherein the capacitor and the resistor are components of a Zobel-Filter.

E. The in-ear audio device of paragraph A, wherein the first loudspeaker component includes an armature with a coil of wire suspended between two magnets that oscillates during use to produce sound waves.

F. The in-ear audio device of paragraph A, further comprising: a second loudspeaker component having a first electrode and a second electrode, the first electrode of the second loudspeaker coupled to the first electrode of the first loudspeaker and the second electrode of the second loudspeaker coupled to the second electrode of the first loudspeaker.

G. The in-ear audio device of paragraph F, wherein the first loudspeaker component and the second loudspeaker component are a tuned pair.

H. The in-ear audio device of paragraph F, wherein the first loudspeaker component and the second loudspeaker component are configured in parallel to the capacitor and the resistor.

I. The in-ear audio device of paragraph A, wherein the in-ear audio device is an earbud.

J. The in-ear audio device of paragraph A, wherein the in-ear audio device is a hearing aid or personal sound amplifier.

K. A circuit comprising: a first loudspeaker component; a second loudspeaker component configured in parallel to the first loudspeaker component and wherein the first loudspeaker component and the second loudspeaker component are configured to jointly output sound waves; and a Trebuchet Cell configured in parallel to the first loudspeaker component and the second loudspeaker component to linearize an impedance response of the first loudspeaker component and the second loudspeaker component during use.

L. The circuit of paragraph K, wherein the Trebuchet Cell includes a first resistor and a first capacitor.

M. The circuit of paragraph L, wherein: the first resistor has a resistance between 10 ohms and 20 ohms; and the first capacitor has a capacitance between 2.5 uF and 7.5 uF.

N. The circuit of paragraph L, wherein: the first resistor has a resistance of 15 ohms; and the first capacitor has a capacitance of 5 uF.

O. The circuit of paragraph L, wherein the Trebuchet Cell includes a second resistor and a second capacitor.

P. The circuit of paragraph K, further comprising: a power source coupled in parallel to the Trebuchet Cell such that the Trebuchet Cell is between the power source and the first loudspeaker and the second loudspeaker.

Q. A device comprising: a first loudspeaker component having a first electrode and a second electrode; a Trebuchet Cell having a first electrode and a second electrode, the first electrode of the Trebuchet Cell coupled to the first electrode of the first loudspeaker component and the second electrode of the Trebuchet Cell coupled to the second electrode of the first loudspeaker component and wherein the Trebuchet Cell linearizes an impedance response of the first loudspeaker component during use; and a power source having a first electrode and a second electrode, the first electrode of the power source coupled to the first electrode of the Trebuchet Cell and the second electrode of the power source coupled to the second electrode of the Trebuchet Cell.

R. The device of paragraph Q, wherein the Trebuchet Cell includes a first resistor and a first capacitor.

S. The device of paragraph R, wherein: the first resistor has a resistance of 15 ohms; and the first capacitor has a capacitance of 5 uF.

T. The device of paragraph R, wherein: the first resistor has a resistance between 10 ohms and 20 ohms; and the first capacitor has a capacitance between 2.5 uF and 7.5 uF.

U. The device of paragraph Q, further comprising: a second loudspeaker component having a first electrode and a second electrode, the first electrode of the second loudspeaker coupled to the first electrode of the first loudspeaker and the second electrode of the second loudspeaker coupled to the second electrode of the first loudspeaker.

V. The device of paragraph Q, wherein the first loudspeaker is a balance armature loudspeaker.

While the example clauses described above are described with respect to one particular implementation, it should be understood that, in the context of this document, the content of the example clauses can also be implemented via a method, device, system, a computer-readable medium, and/or another implementation. Additionally, any of the examples A-V may be implemented alone or in combination with any other one or more of the examples A-V.

### CONCLUSION

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. An in-ear audio device comprising:
a first loudspeaker component having a first electrode and a second electrode;
a resistor having a first electrode and a second electrode, the first electrode of the resistor coupled to the first electrode of the first loudspeaker component;
a capacitor having a first electrode and a second electrode, the first electrode of the capacitor coupled to the second electrode for the first loudspeaker component and the second electrode of the capacitor coupled to the second electrode of the resistor.

2. The in-ear audio device of claim 1, further comprising:
a power source having a first electrode and a second electrode, the first electrode of the power source coupled to the first electrode of the resistor and the second electrode of the power source coupled to the first electrode of the capacitor.

3. The in-ear audio device of claim 1, wherein the capacitor and the resistor are components of a Trebuchet Cell.

4. The in-ear audio device of claim 1, wherein the capacitor and the resistor are components of a Zobel-Filter.

5. The in-ear audio device of claim 1, wherein the first loudspeaker component includes an armature with a coil of wire suspended between two magnets that oscillates during use to produce sound waves.

6. The in-ear audio device of claim 1, further comprising:
a second loudspeaker component having a first electrode and a second electrode, the first electrode of the second loudspeaker coupled to the first electrode of the first loudspeaker and the second electrode of the second loudspeaker coupled to the second electrode of the first loudspeaker.

7. The in-ear audio device of claim 6, wherein the loudspeaker component and the second loudspeaker component are a tuned pair.

8. The in-ear audio device of claim 6, wherein the loudspeaker component and the second loudspeaker component are configured in parallel to the capacitor and the resistor.

9. The in-ear audio device of claim 1, wherein the in-ear audio device is an earbud, a hearing aid or personal sound amplifier.

10. A circuit comprising:
a first loudspeaker component;
a second loudspeaker component configured in parallel to the first loudspeaker component and wherein the first loudspeaker component and the second loudspeaker component are configured to jointly output sound waves; and
a Trebuchet Cell configured in parallel to the first loudspeaker component and the second loudspeaker component to linearize an impedance response of the first loudspeaker component and the second loudspeaker component during use.

11. The circuit as recited in claim 10, wherein the Trebuchet Cell includes a first resistor and a first capacitor.

12. The circuit as recited in claim 11, wherein:
the first resistor has a resistance between 10 ohms and 20 ohms; and
the first capacitor has a capacitance between 2.5 uF and 7.5 uF.

13. The circuit as recited in claim 11, wherein:
the first resistor has a resistance of 15 ohms; and
the first capacitor has a capacitance of 5 uF.

14. The circuit as recited in claim 11, wherein the Trebuchet Cell includes a second resistor and a second capacitor.

15. The circuit as recited in claim 10, further comprising:
a power source coupled in parallel to the Trebuchet Cell such that the Trebuchet Cell is between the power source and the first loudspeaker and the second loudspeaker.

16. A device comprising:
a first loudspeaker component having a first electrode and a second electrode;
a Trebuchet Cell having a first electrode and a second electrode, the first electrode of the Trebuchet Cell coupled to the first electrode of the first loudspeaker component and the second electrode of the Trebuchet Cell coupled to the second electrode of the first loudspeaker component and wherein the Trebuchet Cell linearizes an impedance response of the first loudspeaker component during use; and
a power source having a first electrode and a second electrode, the first electrode of the power source coupled to the first electrode of the Trebuchet Cell and the second electrode of the power source coupled to the second electrode of the Trebuchet Cell.

17. The device of claim 16, wherein the Trebuchet Cell includes a first resistor and a first capacitor.

18. The device of claim 17, wherein:
the first resistor has a resistance between 10 ohms and 20 ohms; and
the first capacitor has a capacitance between 2.5 uF and 7.5 uF.

19. The device of claim 16, further comprising:
a second loudspeaker component having a first electrode and a second electrode, the first electrode of the second loudspeaker coupled to the first electrode of the first loudspeaker and the second electrode of the second loudspeaker coupled to the second electrode of the first loudspeaker.

20. The device of claim 16, wherein the first loudspeaker is a balance armature loudspeaker.
